(19) United States
(12) Patent Application Publication
(10) Pub. No.: US 2015/0136883 A1
(43) Pub. Date: May 21, 2015

(54) ROTOR MILL HAVING DIRECT OR INDIRECT COOLING OF THE MILLING CHAMBER OF THE ROTOR MILL

(71) Applicant: RETSCH GMBH, Haan (DE)

(72) Inventors: Matthias Niewind, Wulfrath (DE); Frank Janetta, Bottrop (DE)

(21) Appl. No.: 14/406,588

(22) PCT Filed: Jun. 14, 2013
(86) PCT No.: PCT/EP2013/062380

§ 371 Date: Dec. 9, 2014

(30) Foreign Application Priority Data
Jun. 14, 2012 (DE) 10 2012 105 166.6

(51) Int. Cl. B02C 18/16; B02C 18/06

(52) U.S. Cl. CPC B02C 18/16; B02C 18/062
USPC 241/66; 241/65

(57) ABSTRACT

Rotor mill for laboratory operation, comprising a rotor coupled to a drive motor as a milling tool, a ring sieve (28) surrounding the milling chamber (25) of the rotor mill (18) and an annular connecting container (26) for the ground milling material, which collecting container is arranged on the outer circumference of the ring sieve (28) and can be inserted into the housing of the rotor mill and is provided with a cover (29), the milling unit comprising the rotor (18), the ring sieve (28) and the collecting container (26) being closable by a housing cover (15) having a milling material inlet opening (17), is characterized in that at least one component of the milling unit and/or of the rotor mill that directly or indirectly surrounds the milling chamber (25) of the rotor (18) is designed for conducting and/or accommodating a cooling medium and/or for cooling by means of a gaseous cooling fluid flowing around on the outside, said gaseous cooling fluid having been introduced into the housing.

The invention relates to a rotor mill for laboratory operation comprising a rotor coupled to a drive motor as milling tool, a ring sieve surrounding the milling chamber of the rotor and an annular collecting container for the ground milling material, arranged on the outer circumference of the ring sieve and which annular collecting container having been provided a cover can be inserted into the housing of the rotor mill, wherein the milling unit comprising the rotor, ring sieve and collecting container can be closed by a housing cover being provided an inlet opening for the milling material.

A rotor mill having above features is disclosed in EP 0 727 254 B2. In said rotor mill, the energy input required for the crushing process is important in as the crushing process is not allowed to introduce excessive energy into the milling material since this could cause excessive heating of the same. Thus, when crushing, for instance plastic material, the glass transition temperature or softening temperature of the plastic material could be exceeded, causing sticking or clogging of the ring sieve.

In order to prevent said problem, state of art already suggests introducing into the milling chamber a suitable cooling medium along with the milling material such as dry ice or liquid nitrogen so that the temperature of the milling material into which the cooling medium is introduced does not exceed the maximum permissible temperature limit during the milling process. Implementation of such a procedure would be comparatively complicated and partly also dangerous. Moreover, when using conventional mills, the design is such that room temperature air which is sucked in from the area surrounding the rotor mill is flowing through the space between the collecting container and the mill housing.

Thus, object of the invention is to prevent an excessive energy input into the milling material by designing the rotor mill accordingly.

According to the invention said problem is solved by the independent claims as well as preferred embodiments of the same, which have been given at the end of this description.

The invention is based on the concept that at least one component of the milling unit and/or the rotor mill surrounding the milling chamber of the rotor is designed for conducting and/or accommodating a cooling medium and/or for being cooled by external means with a gaseous cooling fluid introduced into the housing. Said invention is advantageous in that heating of the milling material is prevented, reduced or slowed down by cooling the components of the milling unit or rotor mill respectively, coming directly or indirectly into contact with the milling material, so that ultimately the milling material inside the rotor mill does not exceed the permissible milling material temperature limits.

According to a first embodiment of the invention it can be provided for the outer wall of the collecting container to be designed as having double walls. Said double-walled design of the collecting container allows conducting a suitable liquid or gaseous cooling medium continuously or discontinuously through the walls of the collecting container or in case of double walls, to introduce discontinuously a suitable cooling medium such as dry ice or cold water or liquid nitrogen. As gaseous cooling medium for instance, the gas phase of nitrogen can be used, the same being introduced into the collecting container in its liquid state.

Insofar as an alternative embodiment of the invention provides for the covering of the collecting container to have double walls, cooling of the cover can be achieved in the same manner.

According to one embodiment of the invention it can be provided to mount cooling coils on the outer surface of the collecting container and/or the cover, in order to conduct a cooling medium through the same. In this manner, cooling of the walls of the collecting container or the cover of the same is also possible.

In an alternative embodiment of the invention, the wall of the collecting container and/or the cover of the same can be provided coils, so that a stream of a gaseous medium introduced into the rotor mill cools the respective components by means of the cooling medium flowing through the cooling coils. As gaseous cooling medium here again the gas phase of nitrogen being discharged from a collecting container for liquid nitrogen can be used as well as pre-cooled air which is discharged from a suitable device. In particular, the space between the collecting container and the housing of the rotor mill can be flushed with pre-cooled air so that a cooling effect is produced by the cooling medium flowing around the cooling fins.

Alternatively or in addition to the above described steps it can be provided for the collecting container to be divided into separate sections by means of partitions, with at least one section serving as collecting area for the ground milling material and at least one section being used for cooling the collecting container.

Thus with the above described arrangements for cooling the collecting container and/or the cover it is possible to direct the cooling to one or more specific sections of the collecting container.

In another alternative embodiment, for cooling the cover of the collecting container it can be provided for the cover of the collecting container to have a bowl-shaped upper side with the side facing the housing being provided a depression for receiving a cooling medium. Said depression, for instance, can be filled with dry ice or liquid nitrogen.

Alternatively or in addition, for cooling the collecting container or the cover of the same according to one embodiment of the invention it can be provided for the ring sieve to be designed as having double walls in at least one part of its structure. By cooling the ring sieve in this manner, a component is used for cooling which comes directly into contact with the milling material during the grinding process, thus achieving a greater cooling effect.

In particular in this case it can be provided for the ring sieve to have an upper and a lower reinforcement ring, with said enforcement ring being double-walled as well as double-walled supporting bars distributed all over its circumference connecting the upper and lower reinforcing ring.

Alternatively, the ring sieve can be provided an upper and a lower reinforcing ring as well as double-walled supporting bars distributed over its circumference and connecting the upper and the lower reinforcing ring.

Thus, in both the embodiments a cooling medium can be conducted continuously or discontinuously through the components of the ring sieve being designed as having double walls.

In order to further improve the cooling of the ring sieve, according to one embodiment of the invention, the ring sieve is connected to the cover thus forming a part of the same.

Again, alternatively as well as additionally, cooling of the milling material being subjected to a grinding process inside the milling chamber can be achieved by cooling the bottom of the milling chamber accordingly. Insofar as the generic rotor mill described in EP 0 727 254 B2 comprises a base plate, designed as labyrinth plate, it can be provided for the same to be interspersed with cooling channels. Analogue to the proposal for the collecting container and the cover of the same, alternatively or additionally, it can be provided for the labyrinth plate to have cooling ribs mounted, designed for a gaseous cooling fluid flowing around on the outside.

One proposal for cooling a component directly surrounding the milling chamber is to provide the housing cover a pressure disc, with pressure being applied to the cover of the collecting container and to provide the pressure disc with cooling channels. Alternatively, for cooling the pressure disc, the same shall be pro-vided cooling ribs for a gaseous cooling liquid to flow around on the outside.

In this case too, the gas phase of nitrogen stored in liquid form in a vessel or pre-cooled air can be used as gaseous cooling fluid.

The design of the rotor mill by means of which above invention is realized, is described in the attached drawing, wherein show:

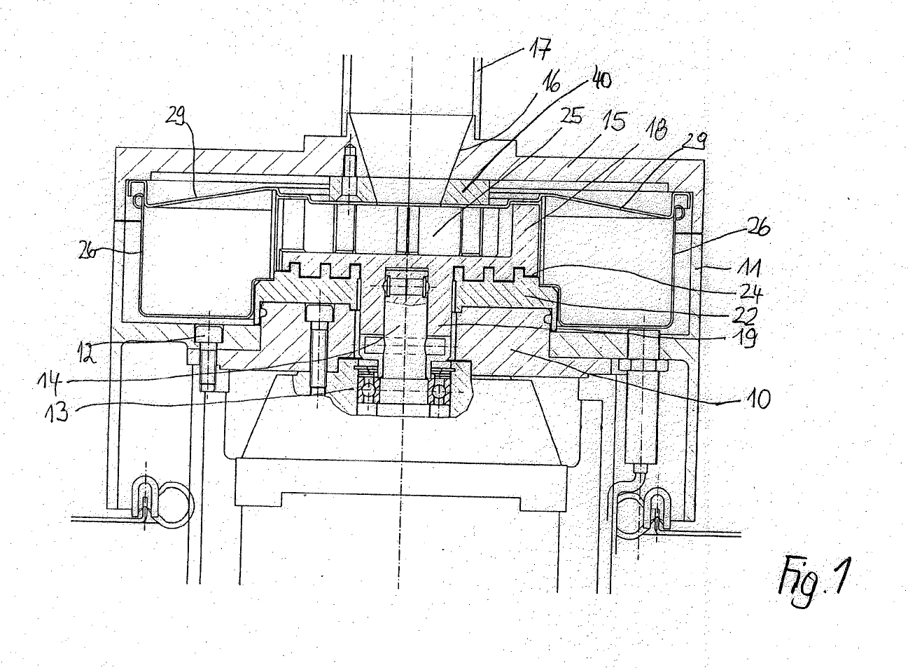

FIG. 1 sectional view of the functional part of a rotor mill

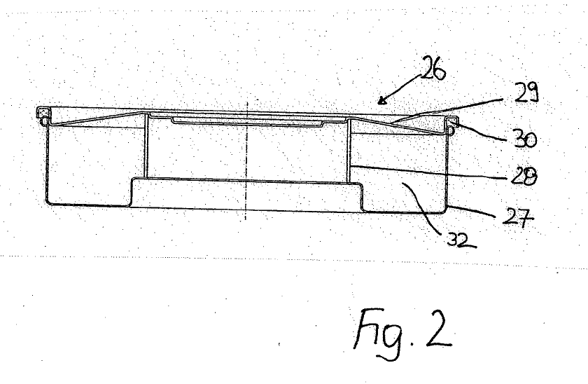

FIG. 2 illustration of a collecting container together with ring sieve

The rotor mill, the basic structure of which is shown in FIG. 1, comprises a base body 10, on which a pot-shaped upper part 11 is mounted as housing by means of screws. In the base body 10 a motor part 13 is arranged, an upward motor shaft 14 of which is projecting over the base body 10, extending into the upper part 11. The housing assembly is to be completed with a housing cover 15 covering the upper part 11. A funnel 16 is arranged within the housing assembly and connected to a material inlet 17.

A rotor 18 is put over the motor shaft 14 by means of a sleeve-like attachment forming a permanent connection with the same. Between the base body 10 and the rotor 18 a labyrinth plate 22 having corresponding projections is arranged on which the rotor 18 having corresponding labyrinth projections is running, thus sealing the milling chamber 25 defined by the rotor 18 against the motor part 13.

As illustrated in FIGS. 1 and 2, an annular collecting container 26 can be inserted into the upper part 11 comprising an outer wall 27 and a ring sieve 28 being fixed at an inner circumference, with said ring sieve 28 enclosing the rotor or milling chamber respectively when the collecting container is inserted into the housing. The collecting container 26 is provided an individual upper cover 29, which is sealed against the outer edge of the same by means of a circumferential seal 30, closing the collecting container 26 as well as overlapping the milling chamber 25.

According to FIG. 1 a pressure disc 40 is arranged on the bottom side of the housing cover 15 projecting over the upper part of the same, applying pressure to the cover 29 of the collecting container 26 when the housing cover is closed thus fixing the collecting container 26 inside the housing.

When operating the rotor mill, the collecting container 26 is fixed inside the upper part 11 and the housing cover 15 is closed, with the housing cover 15 pressing against the cover 29 of the collecting container 26 through the pressure disc 40, thus fixing the same in an unmovable manner. The milling material to be ground reaches the milling chamber 25 via the material inlet 17 and the funnel 16 where it is crushed by the rotor 18 running at high speed. The ground milling material enters the annular space 32 of the collecting container 26 via the ring sieve 28. After completion of the crushing process the housing cover 15 is opened and the collecting container 26 which is closed by the cover 29 can be removed from the upper part 11.

If such a rotor mill is to be designed for direct or indirect cooling of the components surrounding the milling chamber 25, the different options for achieving the same have not been illustrated in detail, since they have been already revealed in the above description.

Thus, the collecting container 26 and/or the cover 29 of the collecting container 26 can be double-walled in order to conduct a suitable cooling medium through the same. Needless to say, the double-walled sections of the collecting container 26 are to be connected to a cooling medium inlet and outlet. In addition or alternatively, cooling coils can be arranged on the outside of the collecting container and/or the cover through which a cooling medium is conducted.

Alternatively or in addition, the wall 27 and/or the cover 29 of the collecting container 26 can be provided cooling fins being supplied a gaseous cooling fluid introduced into the housing of the rotor mill and thus providing adequate cooling.

Then again it can be provided for the cover 29 of the collecting container 26 to be designed in the shape of a bowl having a depression on its upper side, in which a suitable cooling medium such as dry ice, cold water or liquid nitrogen can be filled.

Another option for cooling the collecting container is to divide the collecting container 26 into individual sections by means of partitioning walls, with at least one section serving as collecting area for the ground milling material and at least one other section is used for cooling the collecting container.

Another proposal is to cool the ring sieve 28 enclosing the milling chamber 25, for which purpose at least one part of the ring sieve shall be designed as having a double wall. For instance, the ring sieve 28 (not shown in the illustration) can be provided an upper and a lower reinforcing ring as well as supporting bars distributed over the circumference in the spaces between the same. Said parts of the ring sieve can again be double-walled, so that by conducting a cooling medium through the same or by filling the same with a cooling medium, cooling of the ring sieve is achieved. Here too adequate connections for the cooling medium shall be provided.

Then again, additionally or alternatively, the milling chamber 25 can be cooled by providing the labyrinth plate 22 cooling channels or alternatively or additionally, by providing cooling fins, around which the gaseous cooling fluid introduced into the housing, is flowing.

And finally, the pressure disc 40 of the housing cover 15, applying pressure to the cover 29 of the collecting container 26 can either be provided cooling channels or the cooling can be provided by means of cooling fins arranged on the same around which a gaseous liquid cooling fluid is flowing.

The features, claims, summary and drawings disclosed in the above description of the invention can be used individually or in any combination for realizing the invention and different embodiments of the same.

1. Rotor mill for laboratory operation comprising a rotor coupled to a drive motor as milling tool, a ring sieve surrounding the milling chamber of the rotor and an annular collecting container for the ground milling material being arranged on the outer circumference of the ring sieve which can be inserted into the housing of the rotor mill and being provided a cover, wherein the milling unit comprising of the rotor, ring sieve and the collecting container can be closed by a housing cover the same being provided with a milling material inlet opening, characterized in that at least one component of the milling unit and/or of the rotor mill that directly or indirectly surrounds the milling chamber of the rotor is designed for conducting and/or accommodating a cooling medium and/or for cooling by means of a gaseous cooling fluid flowing around on the outside, said gaseous cooling fluid having being introduced into the housing.

2. Rotor mill according to claim 1, characterized in that the outer wall of the collecting container is designed as double wall.

3. Rotor mill according to claim 1, characterized in that the cover of the collecting container is designed as double wall.

4. Rotor mill according to claim 1, characterized in that cooling coils are mounted to the outer surface of the collecting container and/or the cover.

5. Rotor mill according to claim 1, characterized in that the wall and/or the cover of the collecting container are provided cooling fins for the inflow of a gaseous cooling fluid.

6. Rotor mill according to claim 1, characterized in that the collecting container is divided by means of partitioning walls in individual sections, with at least one section serving as collecting area for the ground milling material and at least one other section is used for cooling of the collecting container.

7. Rotor mill according to claim 1, characterized in that the cover of the collecting container is dome-shaped on its side facing the housing cover and is provided a depression for receiving the cooling medium.

8. Rotor mill according to claim 1, characterized in that the ring sieve is designed as double-walled, at least in one part of its structure.

9. Rotor mill according to claim 8, characterized in that the ring sieve is provided an upper and a lower reinforcing ring with said enforcing rings being double-walled.

10. Rotor mill according to claim 8, characterized in that the ring sieve is provided an upper and a lower reinforcing ring and in that distributed over the circumference of the same, double-walled supporting bars are provided, connecting the upper and lower reinforcing ring.

11. Rotor mill according to claim 1, characterized in that the ring sieve is connected to the cover and forms a part of the cover.

12. Rotor mill according to claim 1, having a base plate being designed as labyrinth plate supporting the rotor, characterized in that the labyrinth plate is provided cooling channels, interspersing the same.

13. Rotor mill according to claim 1, having a base plate being designed as labyrinth plate supporting the rotor, characterized in that the labyrinth plate is provided cooling fins equipped for a gaseous cooling medium to be conducted through the same.

14. Rotor mill according to claim 1, characterized in that the housing cover comprises a pressure disc applying pressure to the cover of the collecting container and the pressure disc is provided cooling channels put through the same.

15. Rotor mill according to claim 1, characterized in that the housing cover is provided a pressure disc applying pressure to the cover of the collecting container with the pressure disc being provided cooling fins designed for a gaseous cooling liquid flowing around on the outside.
